(19) United States
(12) Patent Application Publication
(10) Pub. No.: US 2021/0106406 A1
(43) Pub. Date: Apr. 15, 2021

(54) SHELL-SHAPED DENTAL APPLIANCE AND ATTACHMENT

(71) Applicant: WUXI EA MEDICAL INSTRUMENTS TECHNOLOGIES LIMITED, Wuxi, Jiangsu (CN)

(72) Inventors: Ketuo ZHOU, Shanghai (CN); Lei HUANG, Shanghai (CN)

(73) Assignee: WUXI EA MEDICAL INSTRUMENTS TECHNOLOGIES LIMITED, Wuxi, Jiangsu (CN)

(21) Appl. No.: 17/041,075

(22) PCT Filed: Jun. 6, 2019
(86) PCT No.: PCT/CN2019/090281

§ 371 Date: Sep. 24, 2020

(30) Foreign Application Priority Data
Sep. 11, 2018 (CN) 201821488698.6

(51) Int. Cl. A61C 7/08

(52) U.S. Cl. CPC A61C 7/08

(57) ABSTRACT

In one aspect of the present application, a shell-shaped dental appliance is provided, which is an integral shell and forms a cavity for receiving teeth and a cavity for receiving an attachment adhesively fixed on a tooth, the cavity for receiving teeth and the cavity for receiving the attachment are continuous, wherein a part of a surface of the cavity for receiving the attachment, which part is close to the root of the tooth, protrudes towards the cusp of the tooth, to snap-fit into an indentation towards the cusp of the tooth formed on a part of a surface of the attachment, which part is close to the root of the tooth.

### FIELD OF THE APPLICATION

The present application generally relates to a shell-shaped dental appliance and an attachment.

### BACKGROUND

Shell-shaped dental appliances such as invisible tooth repositioners and retainers made of polymer materials become more and more popular due to their advantages on cosmetic appearance, convenience of use and hygiene.

A basic requirement for a shell-shaped dental appliance is adequate ability of holding on to teeth. On one hand, the shell-shaped dental appliance shall snugly fit and hold firmly on to teeth so that it will not disengage from the teeth due to factors such as its gravity, tooth repositioning forces and functional forces of muscles. On the other hand, the shell-shaped dental appliance shall remain intact after many times of wearing and removal.

A shell-shaped dental appliance's ability of holding on to teeth is associated with geometries of crowns of the teeth. A dentist may add an attachment on a tooth and form on the shell-shaped dental appliance a corresponding structure that engages with the attachment as per needs, to reinforce the shell-shaped dental appliance's ability of holding on to the teeth. Especially for adolescents (before and during mixed dentition period), their crowns of teeth are usually wider on upper side and narrower on lower side, and are without undercuts or with insufficient undercuts, as a result, the teeth′ ability of holding shell-shaped dental appliances is weak, therefore, attachments for holding shell-shaped appliances usually need to be added. However, there are some problems for use of conventional attachments for holding shell-shaped dental appliances in adolescents orthodontic clinical applications.

First, tooth crowns of adolescents (particularly crowns of deciduous teeth) are significantly shorter than those of adults, as a result, there is a dilemma to choose between holding ability and size of conventional attachments for holding shell-shaped dental appliances. The holding ability does not meet requirement if the attachment size is too small, and there is no sufficient space for mounting the attachment with adhesion if the attachment size is too large.

Second, for adolescents in mixed dentition period, the holding ability on the first molar is possibly higher than that of adults. According to statistics of teeth-replacing order, usually first molar (tooth #6) is most likely to be replaced first. When a first permanent molar is used for holding purpose, it is possible that premolars (teeth #4 and 5) are still deciduous teeth and cannot be used for holding purpose. Hence, the holding ability of the attachment on tooth #6 must be higher.

In view of the above, it is necessary to provide a novel shell-shaped dental appliance and an attachment that pairs with it.

### SUMMARY

In one aspect, the present application provides a shell-shaped dental appliance, which is an integral shell, and forms a cavity for receiving teeth and a cavity for receiving an attachment adhesively fixed on a tooth, the cavity for receiving teeth and the cavity for receiving the attachment are continuous with one another, wherein a part of a surface of the cavity for receiving the attachment, which part is close to the root of the tooth, protrudes towards the cusp of the tooth, to snap-fit into an indentation towards the cusp of the tooth formed on a part of a surface of the attachment which part is close to the root of the tooth.

In some embodiments, the part of the surface of the attachment, which part is close to the root of the tooth, and the part of the surface of the cavity for receiving the attachment, which part is close to the root of the tooth, may be cambered surfaces.

In some embodiments, the geometry of the cavity for receiving the attachment may substantially match that of the attachment.

In some embodiments, the cavity may have a geometry selected to reposition the teeth from a first tooth arrangement to a second tooth arrangement.

In some embodiments, the geometry of the cavity may be determined based on the second tooth arrangement of the patient's teeth.

In some embodiments, the geometry of the cavity may substantially match that of the second tooth arrangement of the patient's teeth.

An attachment for being adhesively fixed on a tooth and engaging with a corresponding structure formed on a shell-shaped dental appliance to enhance the holding of the shell-shaped dental appliance on teeth, the attachment comprises a bonding surface, an upper surface and a lower surface, the bonding surface is for adhesively fixing the attachment on the tooth, the upper surface is close to the cusp of the tooth when the attachment is adhesively fixed on the tooth, the lower surface is close to the root of the tooth when the attachment is adhesively fixed on the tooth, and the lower surface forms an indentation towards the tooth cusp so that the corresponding structure of the shell-shaped dental appliance is able to snap-fit into the indentation.

In some embodiments, the upper surface may form a slope towards the tooth root such that the shell-shaped dental appliance can be worn easily.

In some embodiments, the upper surface may be a cambered surface.

In some embodiment, the lower surface may be a cambered surface.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the protection scope of the present application. Unless otherwise specified, the figures are not necessarily drawn to scale, and similar reference numbers therein denote similar components.

FIG. 1 schematically illustrates an attachment in one embodiment of the present application;

FIG. 2 schematically illustrates a tooth having the attachment shown in FIG. 1 mounted thereon;

FIG. 3 schematically illustrates a shell-shaped dental appliance according to one embodiment of the present application; and

FIG. 4 is a schematic cross-sectional view when the shell-shaped dental appliance shown in FIG. 3 is worn on the tooth having the attachment adhesively mounted thereon.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

After a lot of work, the Inventors of the present application developed a novel shell-shaped dental appliance and an attachment that pairs with it.

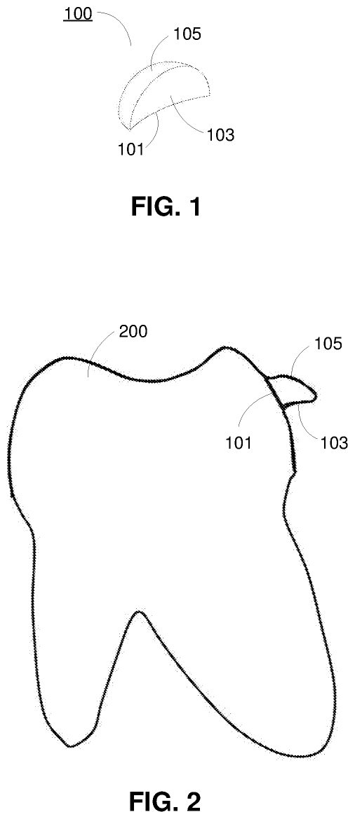

Referring to FIG. 1, it schematically illustrates an attachment 100 in one embodiment of the present application.

The attachment includes a bonding surface 101, a lower surface 103 and an upper surface 105. The bonding surface 101 is for adhesively fixing the attachment 100 on a patient's tooth. When the attachment 100 is fixed adhesively on a patient's tooth, the lower surface 103 is close to the root of the tooth and forms an indentation towards the cusp of the tooth so that a corresponding structure of the shell-shaped dental appliance can snap-fit into the indentation to reinforce retention of the shell-shaped dental appliance on the patient's teeth. The upper surface is close to the cusp of the tooth, and forms a slope towards the toot of the tooth, which can guide the shell-shaped dental appliance, therefore to make it easier to put on the shell-shaped dental appliance.

In one embodiment, the lower surface 103 and the upper surface 105 may be cambered surfaces; in another embodiment, they may also be other types of surfaces, e.g., connected planar surface patches, or connected planar surfaces patches and cambered surface patches, etc.

Referring to FIG. 2, it schematically illustrates a tooth 200 having the attachment 100 shown in FIG. 1 adhesively fixed thereon according to one embodiment of the present application, wherein the bonding surface 101 and the surface of the tooth 200 abut against and adhere to each other.

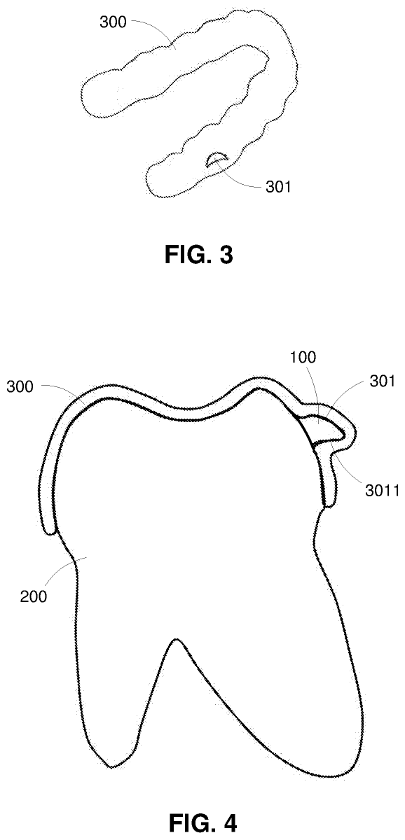

Referring to FIG. 3, it schematically illustrates a shell-shaped dental appliance 300 according to one embodiment of the present application.

The shell-shaped dental appliance 300 is substantially an integral shell and forms a cavity for receiving teeth and a cavity 301 for receiving the attachment, and the two cavities are continuous with one another.

Referring to FIG. 4, it illustrates a schematic cross-sectional view when the shell-shaped dental appliance 300 shown in FIG. 3 is worn on the tooth having the attachment 100 adhesively fixed thereon.

The geometry of the cavity 301 for receiving the attachment substantially matches that of the attachment 100, and its lower surface 3011 forms a bulge towards the cusp of the tooth such that when the shell-shaped dental appliance 300 is worn on the patient's teeth, the lower surface 3011 snap-fits into the lower surface of the attachment 100. Such an engagement additionally enhances the holding of the shell-shaped dental appliance 300 on the patient's teeth.

In one embodiment, the cavity of the shell-shaped dental appliance 300 for receiving teeth has a geometry selected to reposition the patient′ teeth from a first tooth arrangement to a second tooth arrangement. In one embodiment, the geometry of the cavity of the shell-shaped dental appliance 300 for receiving teeth may be determined based on the second tooth arrangement of the patient's teeth. In one embodiment, the geometry of the cavity of shell-shaped dental appliance 300 for receiving teeth may substantially match the second tooth arrangement of the patient's teeth.

In another embodiment, the geometry of the cavity of shell-shaped dental appliance 300 for receiving teeth may be determined based on a current tooth arrangement of the patient's teeth. In a further embodiment, the geometry of the cavity of shell-shaped dental appliance 300 for receiving teeth may substantially match the current tooth arrangement of the patient's teeth.

In some embodiments, the shell-shaped dental appliance 300 may be made of one of the following materials: PC (polycarbonate), PEG (polyethylene glycol) or TPU (thermoplastic polyurethanes).

In one embodiment, the shell-shaped dental appliance 300 may be fabricated using thermoplastic forming technique.

The structures of the attachment and shell-shaped dental appliance of the present application is able to enhance the holding of the shell-shaped dental appliance on the teeth, and may well solve the problem that it is not difficult for conventional shell-shaped dental appliances to hold on to adolescents' teeth firmly. In addition, the engagement of the attachment and the shell-shaped dental appliance of the present application may further be used for tooth extension.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

1. A shell-shaped dental appliance comprising:
an integral shell forming a cavity for receiving teeth and a cavity for receiving an attachment adhesively fixed on a tooth, the cavity for receiving teeth and the cavity for receiving the attachment being continuous,
wherein a part of a surface of the cavity for receiving the attachment proximate to the root of the tooth protrudes towards the cusp of the tooth to snap-fit into an indentation formed on a part of a surface of the attachment proximate to the root of the tooth.

2. The shell-shaped dental appliance of claim 1, wherein the part of the surface of the attachment proximate to the root of the tooth, and the part of the surface of the cavity for receiving the attachment proximate to the root of the tooth are cambered surfaces.

3. The shell-shaped dental appliance of claim 1, wherein the geometry of the cavity for receiving the attachment substantially matches that of the attachment.

4. The shell-shaped dental appliance of claim 1, wherein the cavity has a geometry selected to reposition a patient's teeth from a first tooth arrangement to a second tooth arrangement.

5. The shell-shaped dental appliance of claim 4, wherein the geometry of the cavity is determined based on the second tooth arrangement of the patient's teeth.

6. The shell-shaped dental appliance of claim 4, wherein the geometry of the cavity substantially matches the second tooth arrangement of the patient's teeth.

7. An attachment for being adhesively fixed on a tooth and engaging with a shell-shaped dental appliance having a corresponding structure to enhance the holding of the shell-shaped dental appliance on teeth, the attachment comprising:
a bonding surface;
an upper surface; and
a lower surface,
wherein the bonding surface is for adhesively fixing the attachment on the tooth, the upper surface is proximate to the cusp of the tooth when the attachment is fixed adhesively on the tooth, the lower surface is proximate to the root of the tooth when the attachment is fixed adhesively on the tooth, and the lower surface forms an indentation towards the cusp of the tooth so that the corresponding structure of the shell-shaped dental appliance is able to snap-fit into the indentation.

8. The attachment of claim 7, wherein the upper surface forms a slope towards the root of the tooth such that the shell-shaped dental appliance can be put on easily.

9. The attachment of claim 7, wherein the upper surface is a cambered surface.

10. The attachment of claim 7, wherein the lower surface is a cambered surface.
